(19) United States
(12) Patent Application Publication
(10) Pub. No.: US 2002/0081525 A1
(43) Pub. Date: Jun. 27, 2002

(54) Optical data recording medium

(76) Inventors: Nobuyuki Takamori, Kitakatsuragi-gun (JP); Hideharu Tajima, Tenri-shi (JP); Akira Takahashi, Nara-shi (JP)

Correspondence Address: Dike, Bronstein, Roberts & Cushman, LLP, 130 Water Street, Boston, MA, 02109, US

(21) Appl. No.: 10/002,952

(22) Filed: Nov. 15, 2001

(30) Foreign Application Priority Data
Nov. 15, 2000 (JP) 2000-348413

(51) Int. Cl. G11B 7/24

(52) U.S. Cl. 430/273.1; 430/270.13; 430/945; 369/288; 369/283; 428/64.6

(57) ABSTRACT

An optical data recording medium includes a transparent substrate, a thin film layer formed on the transparent substrate and a protective film which is mainly comprised of a resin and formed on the thin film layer for protecting the thin film layer. The thin film layer is a single layered or multilayered film including at least any one of a dielectric film, a recording film and a reflective film, and an expansion coefficient under humidity (ratio of expansion (1/%) where a difference of relative humidity (vapor content/saturated vapor amount at 25° C.) is increased by 1%) of the protective film is greater than that of the transparent substrate and smaller than 1.7×10⁻⁴(1/%).

### CROSS-REFERENCE TO RELATED APPLICATION

This application is related to Japanese application No. 2000-348413 filed on Nov. 15, 2000 whose priority is claimed under 35 USC §119, the disclosure of which is incorporated by reference in its entirety.

### BACKGROUND OF THE INVENTION

1. Field of the Invention

The present invention relates to an optical data recording medium on which data is recorded and from which data is reproduced, and more particularly, it relates to an optical data recording medium capable of preventing its warp caused by a change in ambient conditions and an elapse of time.

2. Description of Related Art

FIG. 1 is a schematic sectional view illustrating a structure of an optical data recording medium. A conventional optical data recording medium is shown in a plan view and a side view of FIGS. 8(a) and 8(b), respectively.

An optical data recording medium comprises, as shown in FIG. 1, a single layered or multilayered thin film layer 40 including at least any one of dielectric films 41, 43 (silicon nitride), a recording film 42 (TbFeCo) and a reflective film 44 (Al) is formed by sputtering or the like on a disc-shaped substrate 20 made of a polycarbonate. On the thin film layer 40, a protective film 50 such as a resin film for protecting the thin film layer is formed. Further, another protective film 30 such as a resin film for protecting the substrate is formed on a light receiving surface of the substrate.

The substrate 20 is about 1.2 mm thick, the single layered or multilayered thin film layer 40 formed by sputtering is 10-300 nm thick, the protective film 50 is 1-30 μm thick, and the protective film 30 is 1-30 μm thick.

Since the polycarbonate substrate 20 constitutes almost the entire thickness of the optical data recording medium, rigidity of the medium substantially depends on that of the polycarbonate substrate 20. With the sufficient thickness of the polycarbonate substrate 20, deformation of the medium caused by a change in ambient conditions (temperature and humidity) is very small and there is no need to pay attention to a balance between stresses and bending moments generated in the layers.

In recent years, however, data recording and reproducing at high density on and from the optical data recording medium have been required. Accordingly, attempts to increase NA of an objective lens and decrease the substrate thickness have been made for reducing a beam spot diameter. The thickness of the substrate shows a tendency to decrease from a conventional dimension of 1.2 mm to an almost half or less, i.e., 0.6 mm or 0.5 mm. In such a case, the rigidity of the optical data recording medium depends upon not only the polycarbonate substrate 20 but also the stresses or bending moments generated in the layers. Such a medium will remarkably be warped if the ambient conditions (temperature and humidity) are changed. Therefore, it is important to establish an appropriate balance between the thicknesses and the like of the layers.

Japanese Unexamined Patent Publication No. Hei 4(1992)-195745 proposes a method of forming a dielectric film on a back surface of the substrate (where the thin film layer is not formed) for preventing the warp.

FIG. 9 shows a sectional view of an optical data recording medium according to the above publication. Components identical to those shown in FIG. 1 are indicated by the same reference numerals.

As shown in FIG. 9, a dielectric layer 60 is formed on a light receiving surface of a transparent polycarbonate substrate 20. The warp of the optical data recording medium is prevented by equalizing expansion coefficients under humidity of a first dielectric film 41, a recording film 42 and a second dielectric layer 43 formed on a surface opposite to the light receiving surface of the transparent substrate 20 with the expansion coefficient under humidity of the dielectric layer 60 on the light receiving surface of the substrate.

FIG. 10 shows a sectional view of another conventional optical data recording medium according to Japanese Unexamined Patent Publication No. Hei 4(1992)-364248.

The recording medium comprises a substrate 20, a thin film layer 40, a protective film 50 for protecting the thin film layer and a protective film 30 (a dielectric layer) for protecting the substrate. For preventing the warp caused by a change in humidity, an anti-permeation film 70 made of SiO₂ or AlN is formed between the substrate 20 and the protective film 30.

In the above-mentioned conventional recording media according to both of the publications, the dielectric layer (30, 60) must be formed by sputtering or the like on the light receiving surface of the substrate. Accordingly, in the manufacture thereof, the thin film layer 40 is formed on a surface of the substrate and then the substrate is turned over to form the dielectric layer (60, 30) on an opposite surface. Therefore, the manufacture is complicated and the charge of the manufacture facility is raised, which increases the manufacture cost.

In many cases, the expansion coefficient under humidity of the protective film 50 for protecting the thin film layer is greater than that of the polycarbonate substrate 20. If the protective film 50 is formed as thin as possible, the warp of the optical data recording medium 10 due to expansion of the protective film 50 through increase in humidity is controlled. However, when a magnetic field generating means and the thin film layer 40 come too close to each other, the protective film 50 is scratched due to sliding movement of the magnetic field generating means and the medium 10. The reduction in thickness of the protective film 50 is therefore inconvenient because the lifetime of the medium 10 is shortened.

### SUMMARY OF THE INVENTION

The present invention is an optical data recording medium which is easily manufactured and capable of preventing the deformation (warp) caused by a change in temperature and humidity.

The present invention provides an optical data recording medium comprising a transparent substrate, a thin film layer formed on the transparent substrate and a protective film which is mainly comprised of a resin and formed on the thin film layer for protecting the thin film layer, wherein the thin film layer is a single layered or multilayered film including at least any one of a dielectric film, a recording film and a reflective film, and an expansion coefficient under humidity [ratio of expansion (1/%) where a difference of relative humidity (vapor content/saturated vapor amount at 25° C.) is increased by 1%] of the protective film is greater than that of the transparent substrate and smaller than 1.7×10^{31 4}(1/%).

These and other objects of the present application will become more readily apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

FIG. 1 is a schematic sectional view illustrating a structure of an optical data recording medium;

FIG. 2 is a view illustrating how the optical data recording medium is warped;

FIG. 3 is a view illustrating a multilayered beam;

FIG. 4 is a graph illustrating a time dependency of a warp angle of a conventional medium through a change in relative humidity (indicating a high expansion coefficient under humidity and a high Young's modulus);

FIG. 5 is a graph illustrating a time dependency of a warp angle of a medium according to Example 1 of the present invention through a change in relative humidity (indicating a low expansion coefficient under humidity and a high Young's modulus);

FIG. 6 is a graph illustrating a time dependency of a warp angle of a medium according to Example 2 of the present invention through a change in relative humidity (indicating a high expansion coefficient under humidity and a low Young's modulus);

FIG. 7 is a graph illustrating a relationship between an expansion coefficient under humidity and a Young's modulus of the medium according to Example 1;

FIGS. 8(a) and 8(b) are a plan view and a side view each illustrating a structure of a conventional optical data recording medium;

FIG. 9 is a schematic sectional view illustrating a conventional optical data recording medium;

FIG. 10 is a schematic sectional view illustrating another conventional optical data recording medium;

FIG. 11 is a table illustrating settings of components of the medium according to Example 1 of the present invention;

FIG. 12 is a table illustrating settings of components of the conventional medium; and

FIG. 13 is a table illustrating settings of components of the medium according to Example 2 of the present invention.

### DESCRIPTION OF THE PREFERRED EMBODIMENTS

The present invention provides an optical data recording medium comprising a transparent substrate, a thin film layer formed on the transparent substrate and a protective film which is mainly comprised of a resin and formed on the thin film layer for protecting the thin film layer, wherein the thin film layer is a single layered or multilayered film including at least any one of a dielectric film, a recording film and a reflective film, and an expansion coefficient under humidity (ratio of expansion (1/%) where a difference of relative humidity (vapor content/saturated vapor amount at 25° C.) is increased by 1%) of the protective film is greater than that of the transparent substrate and smaller than 1.7×10⁻⁴(1/%).

According to the present invention, the deformation (warp) of the medium itself is prevented to such a degree that substantial influences are not caused to the data recording and reproducing, which improves reliability of the medium through data recording/reproducing as compared with the prior art media.

The present invention further provides an optical data recording medium comprising a transparent substrate, a thin film layer formed on the transparent substrate and a protective film which is mainly comprised of a resin and formed on the thin film layer for protecting the thin film layer, wherein the thin film layer is a single layered or multilayered film including at least any one of a dielectric film, a recording film and a reflective film, and a Young's modulus of the protective film is greater than that of the transparent substrate, greater than 2.0×10⁹ (Pa) and smaller than 1.0×10¹⁰ (Pa).

Here, the protective film for protecting the thin film layer has a thickness of 5 μm or more to 20 μm or less. The transparent substrate may be made of a polycarbonate or a polyolefin.

In order to effectively prevent the warp of the medium, the protective film for protecting the thin film layer is made of a material satisfying the above-mentioned expansion coefficient under humidity and Young's modulus. Examples of such a material include an ultraviolet light curing resin mainly comprised of polyester acrylate, epoxy acrylate, urethane acrylate, or polyether acrylate.

The protective film is preferably made of a material containing a large amount of a poorly hydrophilic component in order to reduce the expansion coefficient under humidity as possible.

The optical data recording medium according to the present invention does not require a protective film 30 for protecting the substrate as provided in the conventional media. However, for preventing the scratches and inhibiting the warp, the protective film 30 for protecting the substrate may be formed on a light receiving surface of the transparent substrate 20, though the total thickness of the medium somewhat increases.

Further, the present invention further provides a method of selecting a protective film in an optical data recording medium, the optical data recording medium comprising a transparent substrate, a thin film layer formed on the transparent substrate and the protective film which is mainly comprised of a resin and formed on the thin film layer for protecting the thin film layer, wherein, on condition that the thin film layer is a single layered or multilayered film including at least any one of a dielectric film, a recording film and a reflective film and the transparent substrate is made of a polycarbonate or a polyolefin with a thickness of 0.5 mm, the protective film is selected such that an expansion coefficient under humidity thereof (ratio of expansion (1/%) where a difference of relative humidity (vapor content/saturated vapor amount at 25° C.) is increased by 1%) is greater than that of the transparent substrate and smaller than 1.7×10⁻⁴(1/%).

Still further, the present invention provides a method of selecting a protective film in an optical data recording medium, the optical data recording medium comprising a transparent substrate, a thin film layer formed on the transparent substrate and the protective film which is mainly comprised of a resin and formed on the thin film layer for protecting the thin film layer, wherein, on condition that the thin film layer is a single layered or multilayered film including at least any one of a dielectric film, a recording film and a reflective film and the transparent substrate is made of a polycarbonate or a polyolefin with a thickness of 0.5 mm, the protective film is selected such that a Young's modulus thereof is greater than that of the transparent substrate, greater than 2.0×10⁹ (Pa) and smaller than 1.0×10¹⁰ (Pa).

First, the deformation (warp) of the optical data recording medium through a change in humidity and its principle will be described.

The optical data recording medium intended by the present invention is comprised of, for example, a transparent substrate 20 made of a polycarbonate and a single layered or multilayered thin film layer 40 including dielectric films 41, 43 (aluminum nitride, silicon nitride), a recording film 42 (TbFeCo) and a reflective film 44 (Al alloy) formed on the substrate by sputtering. On the thin film layer 40 a protective film 50 mainly comprised of a resin is formed to protect the thin film layer 40. Further, a protective film 30 mainly comprised of a resin is formed on a light receiving surface of the substrate to protect the substrate.

Various media with the above-mentioned structure have been commercialized. Objects of the present invention includes: magneto-optical recording media such as MD and MO; media for reproduction only such as CD, DVD and DVD-ROM in which the thin film layer 40 includes the reflective film 44 (Al or the like) only; write-at-once optical media such as CD-R and DVD-R in which the thin film layer 40 includes an organic pigment film and the reflective film 44 (Au, Ag); and phase change optical recording media such as CD-RW, DVD-RW, DVD-RAM and DVR in which the thin film layer 40 includes the dielectric films 41, 43 (ZnS—SiO₂ or the like), the recording film 42 (GeSbTe, AgInSb or the like) and the reflective film 44 (Al alloy or the like).

The optical data recording medium is formed of multiple layers as described above. The layers are different in physical property such as an expansion coefficient under humidity and in stress generated in the layers by a change in humidity.

In general, the transparent polycarbonate substrate 20, the protective film 30 for protecting the substrate and the protective film 50 for protecting the thin film layer each show the expansion coefficient under humidity greater than that of the single layered or multilayered thin film layer 40. Accordingly, the expansion of the single layered or multilayered thin film layer 40 in a direction of a substrate radius is much smaller than that of the other layers.

In such a case, a thickness of the transparent substrate 20 is much greater than that of the protective film 30 and that of the protective film 50. Further, films comprising the thin film layer 40 each show a Young's modulus extremely greater than that of the other layers. Accordingly, the deformation caused by a change in humidity is predominantly derived from the small expansion of the thin film layer 40 and the great expansion of the substrate 20, the protective film 50 or the protective film 30.

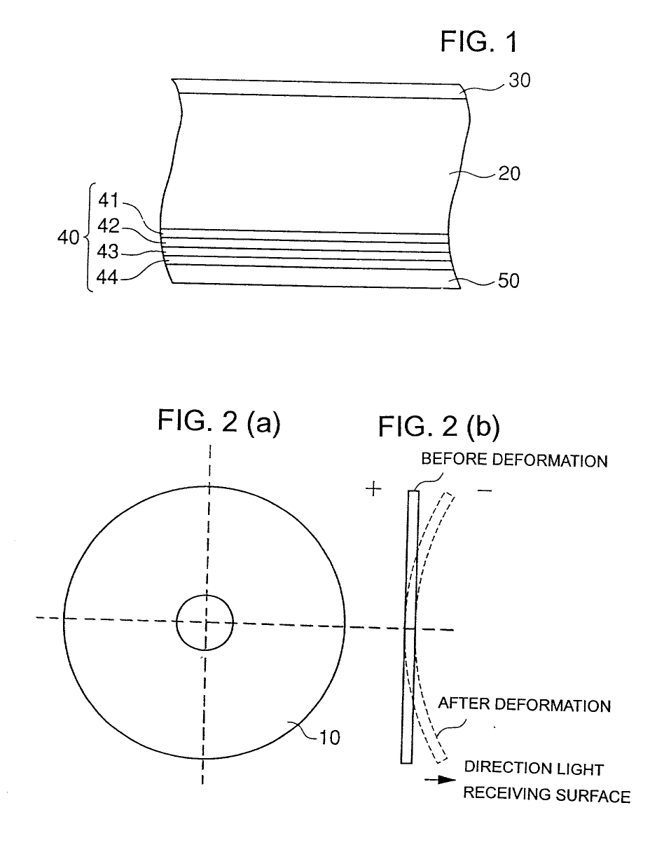

It is known that the protective film 50 or 30 made of an ultraviolet light curing resin generally shows the expansion coefficient under humidity greater than that of the transparent substrate 20 made of a polycarbonate. Therefore, the optical data recording medium 10 is easily warped in a direction perpendicular to a direction of its radius, i.e., a direction of thickness, toward one of the protective films 50 and 30 having a smaller expansion coefficient under humidity than the other. In particular, where the protective film 30 is not formed or the thickness thereof is very small, the medium tends to warp toward the light receiving surface (an upper surface in FIG. 1).

FIG. 2(a) is a plan view and FIG. 2(b) is a side view of the medium illustrating the warp of the medium. The direction of the warp of the medium toward the light receiving surface (the protective film 30) is defined as a minus (−) direction and the direction toward the protective film 50 is defined as a plus (+) direction as shown in FIG. 2(b).

Where the expansion coefficient under humidity, Young's modulus and thickness of the protective film 50 for protecting the thin film layer are suitably adjusted, bending moments of the transparent substrate 20 and the protective film 30 for protecting the substrate generated by a change in humidity are balanced with that of the protective film 50 with respect to a neutral plane, i.e., a plane perpendicular to the film thickness direction. Accordingly, the deformation caused by the humidity change (i.e., the warp in the film thickness direction perpendicular to the radius direction toward the protective film 30 or the light receiving surface) may possibly be alleviated.

In view of the above for the purpose of reducing the warp of the medium through the humidity change, the following rough calculation is carried out to obtain appropriate values of the expansion coefficient under humidity, Young's modulus and thickness of the protective film 50 for protecting the thin film layer.

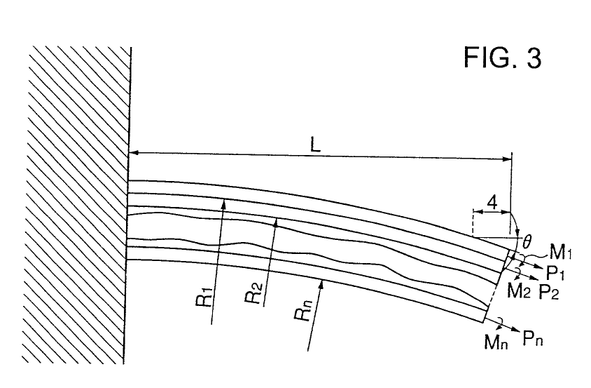

When the humidity is changed, stresses are generated in a radius direction (axial force), a circumference direction and a film thickness direction in the optical data recording medium 10. Since the medium 10 is disc-shaped, the stress in the circumference direction is uniform in the circumference. Further, the stress in the film thickness direction is also applied uniformly in each layer. Accordingly, it is assumed that these stresses do not contribute to the deformation. Therefore, it is considered that the deformation, i.e., the warp of the medium 10 (toward the protective film 50 (+ direction) or the light receiving surface (− direction) in the film thickness direction; evaluated by a warp angle θ, is substituted with warp of a multilayered beam having a section corresponding to that of the medium. FIG. 3 shows such a multilayered beam.

The multilayered beam of FIG. 3 includes n layers. Then n signifies the number of layers comprising the optical data recording medium. In the medium shown in FIG. 1, n is 7.

The warp angle θ in the multilayered beam through a change in humidity is expressed by the formulae (1) to (5) obtained from the balance between axial force Pi(i=1, 2, 3, . . . , n) and bending moment Mi in each layer (“Electronic Devices Utilizing Multilayered Beam Theory” Juhachi ODA, Kanazawa Univ., Japan Machine academy papers, vol. 59, 563, 1777-01782 pp., 1993).

$$\begin{matrix}Mi = \frac{Ei Ii}{Ri} & ( 1 ) \\ {α}_{i} T + \frac{Pi}{btiEi} - \frac{ti}{2 Ri} = {α}_{i + 1} T + \frac{{P}_{i + 1}}{{bt}_{i + 1} {E}_{i + 1}} + \frac{{t}_{i + 1}}{2 {R}_{i + 1}} & ( 2 ) \\ {\sum }_{i = 1}^{n} Pi = 0 & ( 3 ) \\ {\sum }_{i = 1}^{n} Mi + {P}_{1} [ y - \frac{{t}_{1}}{2} ] + {P}_{2} [ y - {t}_{1} - \frac{{t}_{2}}{2} ] + … + {p}_{n} [ y - {t}_{1} - {t}_{2} - … - \frac{{t}_{n}}{2} ] = 0 & ( 4 ) \\ θ = {tan}^{- 1} [ \frac{L - 2}{R} ] & ( 5 )\end{matrix}$$

Symbols in the formulae (1)-(5) have the following meanings:

a₁: expansion coefficient under humidity of an i-layer;

E₁: Young's modulus of the i-layer;

t₁: thickness of the i-layer;

Pᵢ: axial force in the i-layer;

M₁: bending moment in the i-layer;

Rᵢ: radius of curvature in the i-layer;

I₁:secondary moment of section of the i-layer;

b: beam width (defined as a unit length);

T: amount of humidity change (%);

L: beam length;

y: position of a neutral plane in the n layered beam; and

θ: warp angle at a beam length of 4 mm where the maximum warp is caused.

Since the thickness of each layer is much smaller than the radius of curvature, it is assumed that all the layers (i=1, 2, . . . , n) have the same radius of curvature (R₁=R₂=R₃= . . . Rₙ=R). Here, the ratio of expansion of a substance where a difference of relative humidity is increased by 1% is defined as a positive expansion coefficient under humidity and a unit thereof is 1/%. The difference of relative humidity signifies a value of vapor content/saturated vapor amount at 25° C.

In order to control the warp of the medium caused by a change in relative humidity, the Young's modulus, expansion coefficient under humidity and thickness of the protective film 50 for protecting the thin film layer are selected by using the above formulae such that the warp angle θ is reduced. That is, these formulae allow selecting the Young's modulus and the like in order to arrange the position of the neutral plane (y) within the thin film layer during the humidity change. Moreover, it is understood from these formulae that, where the Young's modulus and the expansion coefficient under humidity are as small as those of the substrate 20, it is possible to inhibit the warp by arranging the position of the neutral plane (y) in the thin film layer 40 such as a recording film.

Optical data recording media manufactured according to the above principle will be described by way of examples. The optical data recording media of the examples do not include the protective film 30 for protecting the substrate. If the protective film 30 is provided, thicknesses of the other layers (in particular the protective film 50 for protecting the thin film layer) must be determined appropriately in view of the presence of the protective film 30.

### EXAMPLE 1

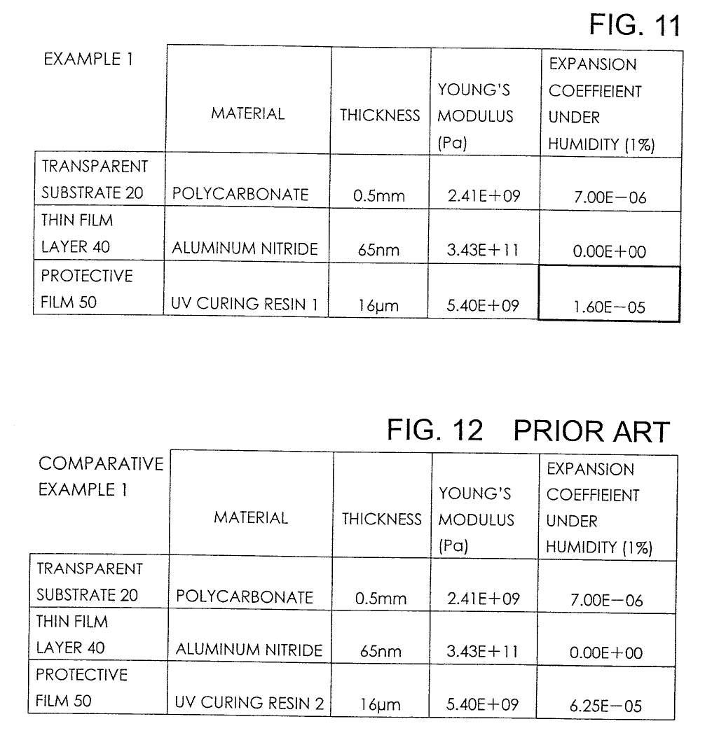

On a polycarbonate substrate (the transparent substrate 20) an aluminum nitride thin film layer (the thin film layer 40) and an ultraviolet light (UV) curing resin 1 (the protective film 50 for protecting the thin film layer) which is designed on the basis of the formulae (1)-(5) are formed to provide an optical data recording medium of Example 1. Further, an optical data recording medium of Comparative Example 1 is provided by forming a thin film layer and a conventional UV curing resin 2 (the protective film 50) on a polycarbonate substrate. FIGS. 11 and 12 describe the structures of the medium according to Example 1 and Comparative Example 1, respectively.

As seen in FIGS. 11 and 12, the two optical data recording media are different in expansion coefficient under humidity of the UV curing resin. The optical data recording medium of Example 1 specified in FIG. 11 has the smaller expansion coefficient under humidity than that of the comparative medium. In both media, the transparent substrate 20 has an internal diameter of 8 mm, an external diameter of 50 mm and a thickness of 0.5 mm.

In the optical data recording medium according to Example 1 of the present invention, selected is a protective film 50 for protecting the thin film layer having an expansion coefficient under humidity of 1.60×10⁻⁵ which is smaller than that of the conventional UV curing resin 2 and a thickness of 16 μm which is determined by the formulae (1)-(5). For comparison with the conventional optical data recording medium specified in FIG. 12, the two media are subjected to a change in ambient conditions such that the humidity increases from 50%RH to 90%RH at 25° C. Thus, variation of the warp angle θ (Δθ) at the circumference (r=24 mm) through an elapse of time is measured.

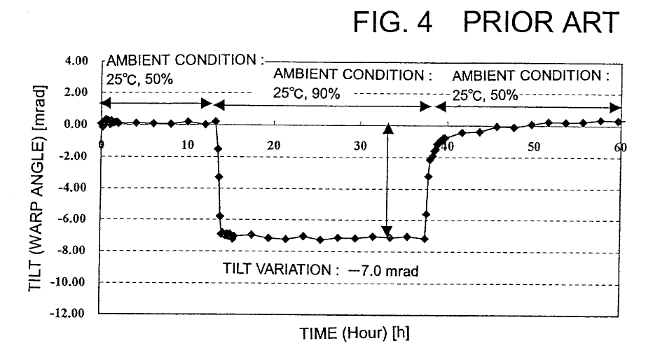

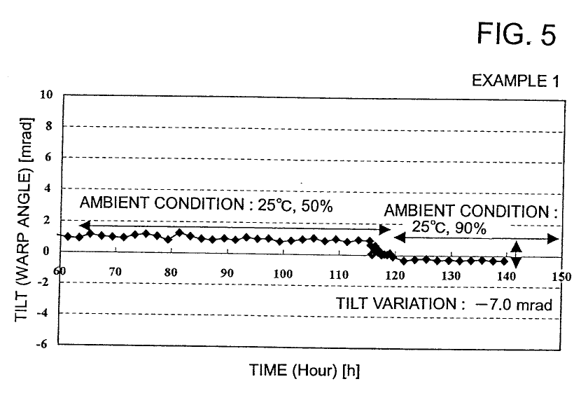

FIGS. 4 and 5 each show a graph illustrating a relationship between the variation of the warp angle (tilt with respect to the radius direction: mrad) and time (hour) under a change in relative humidity. FIG. 4 shows the graph of the conventional optical data recording medium of FIG. 12 and FIG. 5 shows the graph of the optical data recording medium according to Example 1 of the present invention of FIG. 11.

The warp angle in a plus quantity indicates that the medium is warped toward the protective film 50 and the warp angle in a minus quantity indicates that the medium is warped toward the opposite direction, i.e., the protective film 30 (light receiving surface).

According to FIGS. 4 and 5, the conventional medium and the medium of the invention show the expansion coefficient under humidity of 6.25×10⁻⁵ (1/%) and 1.60×10⁻⁵ (1/%), respectively.

That is, FIG. 4 indicates that the protective film 50 in the conventional medium exhibits a high expansion coefficient under humidity and a high Young's modulus, whereas FIG. 5 indicates that the protective film 50 in the medium according to the present invention exhibits a low expansion coefficient under humidity and a high Young's modulus.

Referring to FIG. 4, the warp angle is varied to about −7.0 mrad when the humidity is increased to 90%, which indicates that the conventional medium is greatly warped toward the light receiving surface.

In contrast, referring to FIG. 5, the warp angle is varied to about −0.7 mrad even if the humidity is raised to 90%, which indicates that the warp of the medium of the present invention toward the light receiving surface is very small.

According to the optical data recording medium of the present invention, the variation of the warp angle is very small as compared with the medium of Comparative Example 1 even if the humidity is changed in the same manner. That is, in the medium of the present invention, the deformation is inhibited even if the thickness of the protective film 50 is 10 μm or more.

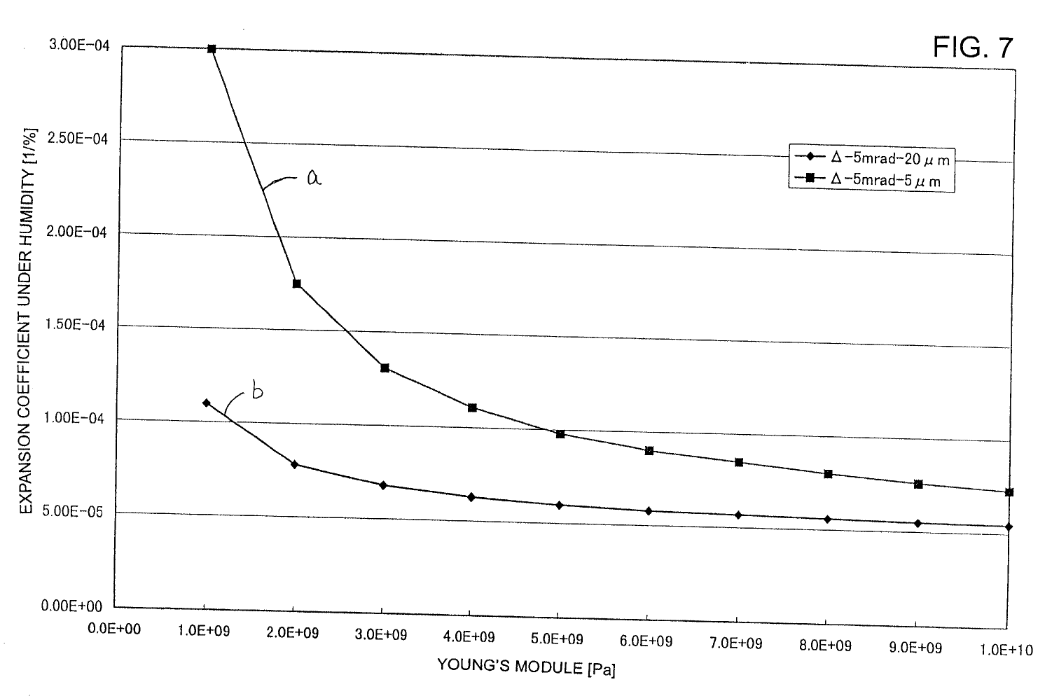

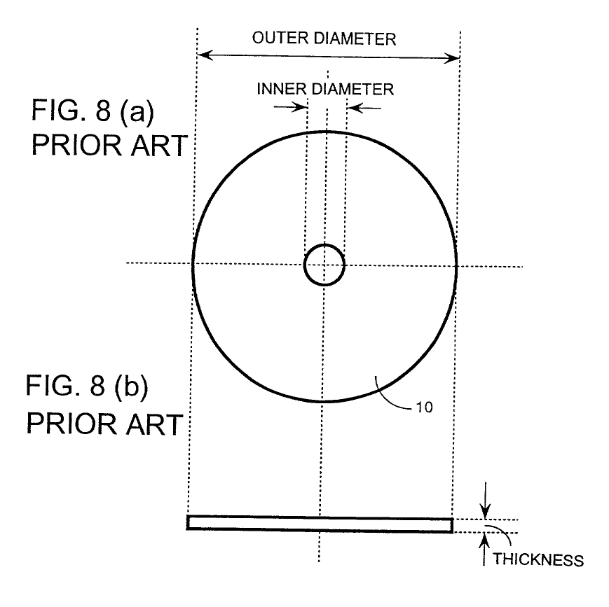

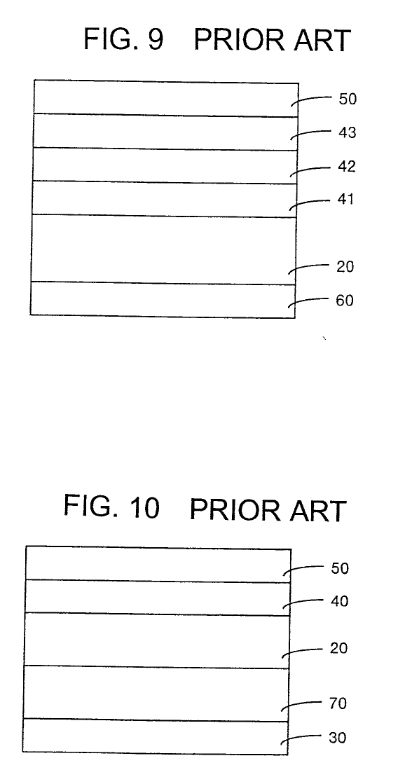

FIG. 7 shows a graph illustrating a relationship between the expansion coefficient under humidity and the Young's modulus of the optical data recording medium according to Example 1 of the present invention specified in FIG. 11. In FIG. 7, curve a is derived from a medium with the protective film 50 of 5 μm thick and the warp angle variation of −5 mrad. Curve b is derived from a medium with the protective film 50 of 20 μm thick and the warp angle variation of −5 mrad.

Where the thickness of the protective film 50 is in the range of 5-20 μm, the relationship between the expansion coefficient under humidity and the Young's modulus is plotted between the curves a and b. At this time, it is necessary to adjust the expansion coefficient under humidity or the Young's modulus such that the warp angle variation falls within the range of 0-5 mrad.

Suppose that the Young's modulus is fixed to 2.0×10⁹ (Pa) and the thickness of the protective film 50 is 20 μm, the expansion coefficient under humidity of the protective film 50 is preferably greater than that of the transparent substrate and smaller than 1.7×10⁻⁴ (1/%).

Accordingly, in order to control the warp angle variation in the range of 0-5 mrad when the protective film 50 is 5-20 μm thick, the expansion coefficient under humidity of the protective film 50 is preferably smaller than 1.7×10⁻⁴ (1/%) and greater than that of the transparent substrate. It is more preferable that the expansion coefficient under humidity is smaller than 7.0×10^{×5} (1/%) and greater than 5.0 ×10⁻⁵ (1/%), i.e., about seven times as great as that of the transparent substrate (7.0×10^{31 6} (1/%)) is sufficient.

As described above, the protective film 50 for protecting the thin film layer is selected to have the expansion coefficient under humidity within the appropriate range. Therefore, the warp of the optical data recording medium is controlled within the appropriate range wherein substantial influences are not caused to the data recording and reproducing.

### EXAMPLE 2

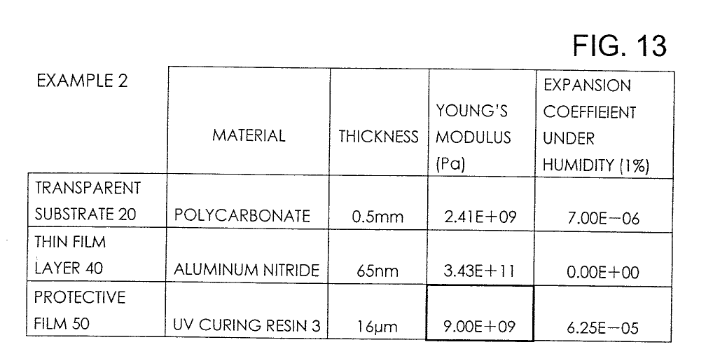

Hereinafter, explanation is given to an optical data recording medium utilizing a UV curing resin 3 exhibiting a low Young's modulus. The UV curing resin 3 is substantially the same as the UV curing resin 1 used in Example 1 except that the Young's modulus is different. FIG. 13 shows the structures of the medium according to Example 2.

Comparing the medium of Example 2 specified in FIG. 13 and the medium of Comparative Example 1 in FIG. 12, they are different in material of the UV curing resin comprising the protective film 50 for protecting the thin film layer. Further, the Young's modulus of the medium of Example 2 (9.00×10⁹(Pa)) is smaller than that of the medium of Comparative Example 1. That is, the protective film 50 in the medium of Example 2 exhibits a low Young's modulus and a high expansion coefficient under humidity.

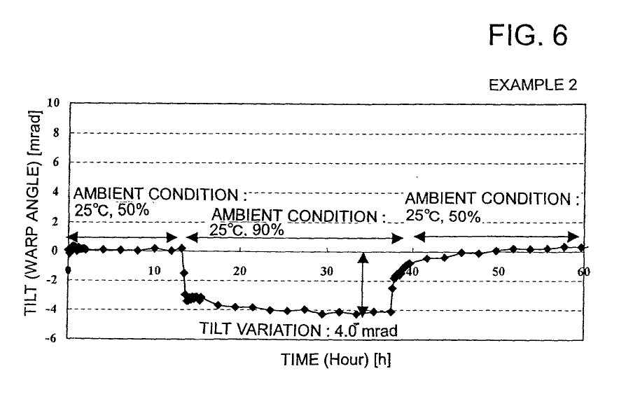

FIG. 6 shows a graph illustrating a relationship between the variation of the warp angle (mrad) and time (hour) through a change in relative humidity.

In the same manner as in Example 1, the two media are subjected to a change in ambient conditions such that the humidity increases from 50%RH to 90%RH at 25° C. Then, the variation of the warp angle θ (Δθ) at the circumference (r=24 mm) through an elapse of time is measured.

FIG. 6 shows that the warp angle is varied to about −4.0 mrad when the humidity is raised to 90%, i.e., the medium is warped toward the light receiving surface. However, the warp is smaller than that caused in the conventional medium shown in FIG. 4.

Further, the graph of FIG. 7 illustrating the relationship between the expansion coefficient under humidity and the Young's modulus indicates that, in order to control the warp angle variation to 5 mrad or less in the case where the protective film 50 is 5-20 μm thick, it is necessary for the protective film 50 to have the Young's modulus at least greater than that of the transparent substrate, greater than 2.0×10⁹ (Pa) and smaller than 1.0×10¹⁰ (Pa). More preferably, the protective film 50 has the Young's modulus in the range of 3.0 ×10⁹ (Pa) to 6.0×10⁹ (Pa).

According to the present invention, the optical data recording medium is provided with the protective film for protecting the thin film layer having the expansion coefficient under humidity which is greater than that of the transparent substrate and falls within a desired range. Therefore, even if the protective film is formed to have a thickness of 10 μm or more, the warp of the medium is controlled more effectively than in the conventional medium to such a degree that substantial influences are not caused to the data recording and reproducing.

Further, since the optical data recording medium is provided with the protective film having the Young's modulus greater than that of the transparent substrate and falls within the range as small as possible, the warp of the medium is reduced as compared with the conventional medium, which improves reliability in the data recording/reproducing.

In the case where the protective film for protecting the substrate is not provided, the optical data recording medium capable of reducing the warp caused by the change in relative humidity can be manufactured with smaller costs and the reliability of the medium through the repetitive data recording/reproducing is improved.

What is claimed is:

1. An optical data recording medium comprising a transparent substrate, a thin film layer formed on the transparent substrate and a protective film which is mainly comprised of a resin and formed on the thin film layer for protecting the thin film layer, wherein the thin film layer is a single layered or multilayered film including at least any one of a dielectric film, a recording film and a reflective film, and an expansion coefficient under humidity [ratio of expansion (1/%) where a difference of relative humidity (vapor content/saturated vapor amount at 25° C.) is increased by 1%] of the protective film is greater than that of the transparent substrate and smaller than 1.7×10⁻⁴(1/%).

2. An optical data recording medium comprising a transparent substrate, a thin film layer formed on the transparent substrate and a protective film which is mainly comprised of a resin and formed on the thin film layer for protecting the thin film layer, wherein the thin film layer is a single layered or multilayered film including at least any one of a dielectric film, a recording film and a reflective film, and a Young's modulus of the protective film is greater than that of the transparent substrate, greater than 2.0×10⁹ (Pa) and smaller than 1.0×10¹⁰ (Pa).

3. An optical data recording medium according to any one of claims 1 and 2, wherein a thickness of the protective film is 5 μm or more to 20 μm or less.

4. An optical data recording medium according to claim 1, wherein the expansion coefficient under humidity of the protective film is 7 or less times as great as that of the transparent substrate, the expansion coefficient under humidity being greater than 7×10⁻⁶ (1/%) and smaller than 5 ×10^{×5}(1/%).

5. An optical data recording medium according to any one of claims 1 and 2, wherein the transparent substrate is made of a polycarbonate or a polyolefin and a thickness thereof is about 0.5 mm.

6. An optical data recording medium according to any one of claims 1 and 2, wherein the protective film is made of an ultraviolet light curing resin.

7. A method of selecting a protective film in an optical data recording medium, the optical data recording medium comprising a transparent substrate, a thin film layer formed on the transparent substrate and the protective film which is mainly comprised of a resin and formed on the thin film layer for protecting the thin film layer, wherein, on condition that the thin film layer is a single layered or multilayered film including at least any one of a dielectric film, a recording film and a reflective film and the transparent substrate is made of a polycarbonate or a polyolefin with a thickness of 0.5 mm, the protective film is selected such that an expansion coefficient under humidity thereof (ratio of expansion (1/%) where a difference of relative humidity (vapor content/saturated vapor amount at 25° C.) is increased by 1/%) is greater than that of the transparent substrate and smaller than 1.7×10⁻⁴(1/%).

8 . A method of selecting a protective film in an optical data recording medium, the optical data recording medium comprising a transparent substrate, a thin film layer formed on the transparent substrate and the protective film which is mainly comprised of a resin and formed on the thin film layer for protecting the thin film layer, wherein, on condition that the thin film layer is a single layered or multilayered film including at least any one of a dielectric film, a recording film and a reflective film and the transparent substrate is made of a polycarbonate or a polyolefin with a thickness of 0.5 mm, the protective film is selected such that a Young's modulus thereof is greater than that of the transparent substrate, greater than 2.0×10⁹(Pa) and smaller than 1.0×10¹⁰(Pa).

9. An optical data recording medium provided with a protective film for protecting a thin film layer selected by the method of claim 7 or 8.
